(19) United States
(12) Patent Application Publication
(10) Pub. No.: US 2010/0143745 A1
(43) Pub. Date: Jun. 10, 2010

(54) NiCoCrl layer for forming dense and solid oxide layers and metallic layer system

(76) Inventor: Werner Stamm, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/515,983

(22) PCT Filed: Aug. 15, 2007
(86) PCT No.: PCT/EP07/58429

§ 371 Date: Jan. 11, 2010

(30) Foreign Application Priority Data
Nov. 24, 2006 (EP) 06024450.6

(51) Int. Cl. B32B 15/01; C22C 30/00; C22C 19/05

(52) U.S. Cl. 428/615; 420/588; 420/443

(57) ABSTRACT

NiCoCrAl layers used as anticorrosive layers characterized by additional corrosion stability enhancing agents that substantially improve the anticorrosive properties are provided. Corrosion stability is not only determined by the composition and the percentage of the main alloy elements of nickel, cobalt, chromium and aluminium, but also by the addition of corrosion stability enhancing agents, such yttrium, cerium, tantalum, niobium, silicon, titanium, zirconium, and hafnium.

### CROSS REFERENCE TO RELATED APPLICATIONS

This application is the US National Stage of International Application No. PCT/EP2007/058429, filed Aug. 15, 2007 and claims the benefit thereof. The International Application claims the benefits of European application No. 06024450.6 EP filed Nov. 24, 2006, both of the applications are incorporated by reference herein in their entirety.

### FIELD OF INVENTION

The invention relates to a metallic layer as claimed in the claims and to a metallic layer system as claimed in the claims.

### BACKGROUND OF INVENTION

Metallic layers are frequently used for bonding ceramic layers to a metallic substrate and/or as an anti-corrosion/anti-oxidation coating.

The formation of an oxide layer on the metal layer is crucial to the bonding of the ceramic layer and to the corrosion and oxidation behavior.

The oxide layer has to be dense and solid such that no oxidizing or corrosive elements, or as few oxidizing or corrosive elements as possible, can diffuse through the dense oxide layer to the metallic substrate, and sufficient strength is required such that the oxide layer does not flake off and any ceramic layer which may be present on the latter can likewise remain bonded thereto.

### SUMMARY OF INVENTION

Therefore, it is an object of the invention to overcome the problem mentioned above.

This object is achieved by means of an NiCoCrAl layer as claimed in claim 1 or a metallic layer system as claimed in claim 20.

### BRIEF DESCRIPTION OF THE DRAWINGS

In the figures:

FIG. 1 shows a layer system according to the invention, comprising a metallic layer,

FIG. 2 shows a gas turbine,

FIG. 3 is a perspective view of a turbine blade or vane, and

FIG. 4 is a perspective view of a combustion chamber.

### DETAILED DESCRIPTION OF INVENTION

The metallic NiCoCrAl layer comprises at least 1% by weight, in particular at most 5% by weight, of cerium (Ce), tantalum (Ta), niobium (Nb), silicon (Si), titanium (Ti), zirconium (Zr), hafnium (Hf) or RE (rare earth element).

The rare earth element is, in particular, yttrium (Y). The NiCoCrAl layer preferably comprises, in addition to the rare earth elements, at least 0.5% by weight, in particular 1% by weight, of cerium (Ce), tantalum (Ta), niobium (Nb), silicon (Si), titanium (Ti), zirconium (Zr) or hafnium (Hf).

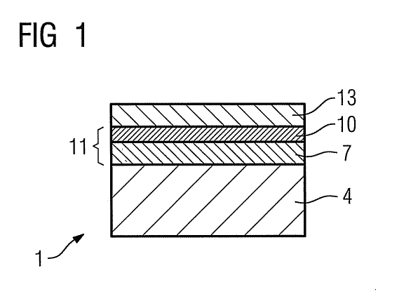

FIG. 1 shows a layer system 1 comprising a metallic layer 11.

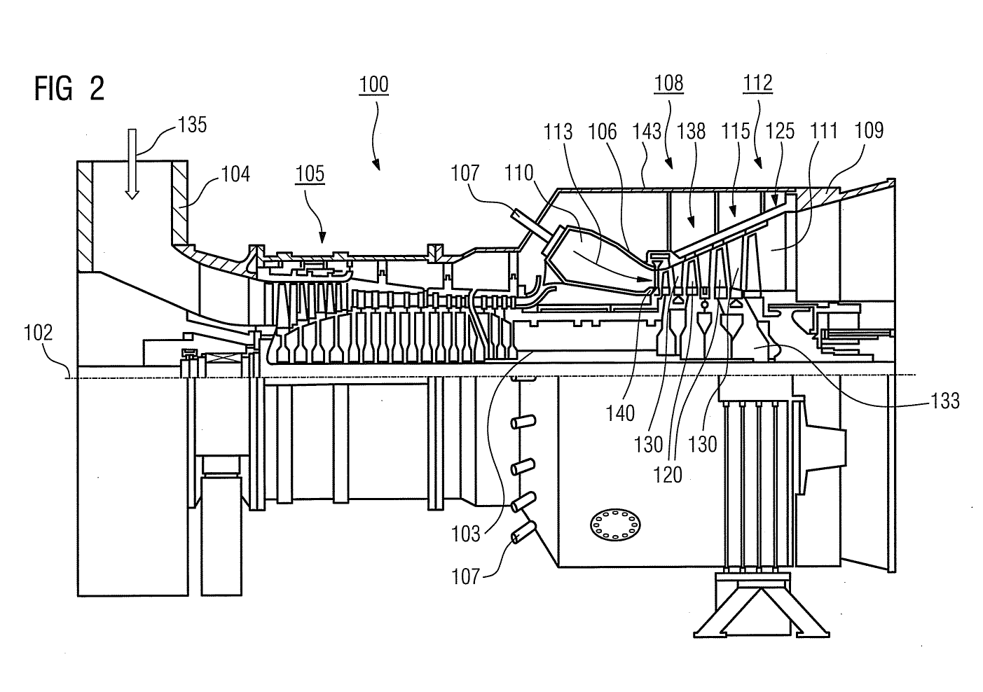

The metallic layer 11 is applied to a substrate 4 which, particularly in the case of components of a gas turbine 100 (FIG. 2), consists of nickel-base or cobalt-base superalloys.

The metallic layer 11 may be used as an overlay layer (not shown) or as a bonding layer, such that in this case an outer ceramic layer 13 is present on the metallic layer 11.

The metallic layer 11 may comprise one layer (layer 11=inner layer 7, as described below) or two layers (inner layer 7 and outer layer 10).

An oxide layer (TGO) is formed on the surface 15 of the metallic layer 11 during operation or as a result of pre-oxidation.

The metallic layer 11 preferably comprises two layers and comprises an inner metallic layer 7 and an outer metallic layer 10 (NiCoCrAl layer); according to the invention, the outer metallic layer 10 comprises at least one of the elements cerium (Ce), tantalum (Ta), niobium (Nb), silicon (Si), titanium (Ti), zirconium (Zr), hafnium (Hf) or RE (rare earth element) as corrosion resistance enhancers.

It is possible to use one, two, three or four of these elements in the outer metallic layer 10, the minimum difference with respect to the rare earth element content (RE) preferably being 0.5% by weight.

The total content of the corrosion resistance enhancers is at least 1% by weight. At least yttrium is used as the rare earth element (RE). With preference, only yttrium is used as the rare earth element (RE).

As well as the addition of the rare earth element, the NiCoCrAl layer comprises at least 0.5% by weight, in particular 1% by weight, of the elements cerium, tantalum, niobium, silicon, titanium, zirconium and/or hafnium.

The silicon, zirconium, cerium and/or hafnium contents are preferably 0.5% by weight, in particular ≧1% by weight.

The maximum content of the corrosion resistance enhancers is 5% by weight, in particular 2.5% by weight.

The outer metallic layer 10 is preferably thinner than the inner metallic layer 7. This is preferably <100 μm.

The corrosion resistance enhancers (Si, Zr, Hf, Ce, Y, Ti, Nb, Ta) may be present in a metallic layer having the following composition (in % by weight):
1. Co-(27-29)Ni-(23-25)Cr-(9-11)Al-(0.5-0.7)Y, in particular Co-28Ni-24Cr-10Al-0.6Y,
2. Ni-(11-13)Co-(20-22)Cr-(10-12)Al-(0.3-0.5)Y-(1.5-2.5)Re, in particular Ni-12Co-21Cr-11Al-0.4Y-2Re,
3. Ni-(24-26)Co-(16-18)Cr-(9-11)Al-(0.3-0.)Y-(1.0-2.5)Re, in particular Ni-25Co-17Cr-10Al-0.4Y-1.5Re,
4. Ni-(27-29)Cr-(7-9)Al-(0.5-0.7)Y-(0.06-0.8)Si, in particular Co-30Ni-28Cr-8Al-0.6Y-0.7Si.

Preference is given to the following combinations of the corrosion resistance enhancers:
Y/Si
Y/Zr
Y/Ce
Y/Al
Y/Si/Zr
Y/Si/Ce
Y/Si/Hf
Y/Zr/Ce
Y/Zr/Hf
Y/Ce/Hf
Y/Si/Zr/Ce
Y/Si/Zr/Hf
Y/Si/Ce/Hf
Y/Zr/Ce/Hf.

Further examples of alloys to which the elements silicon, zirconium, cerium, hafnium or yttrium are preferably added are firstly a system of β-NiAl containing chromium and/or cobalt admixtures, in which the β-NiAl phase is not destroyed, or an alloy which comprises only the γ-Ni phase.

This NiCoCrAl layer may preferably be used in a metallic layer system. Preference is given to using the following composition for the inner layer 7:
Co-(27-29)Ni-(23-25)Cr-(9-11)Al-(0.5-0.7)Y, in particular Co-28Ni-24Cr-10Al-0.6Y,
2. Ni-(11-13)Co-(20-22)Cr-(10-12)Al-(0.3-0.5)Y-(1.5-2.5)Re, in particular Ni-12Co-21Cr-11Al-0.4Y-2Re,
3. Ni-(24-26)Co-(16-18)Cr-(9-11)Al-(0.3-0.)Y-(1.0-2.5)Re, in particular Ni-25Co-17Cr-10Al-0.4Y-1.5Re,
4. Ni-(27-29)Cr-(7-9)Al-(0.5-0.7)Y-(0.06-0.8)Si, in particular Co-30Ni-28Cr-8Al-0.6Y-0.7Si.

The inner layer 7 preferably comprises a composition from these four examples. It preferably consists of one of the four compositions.

The four alloy compositions mentioned above may likewise be used for the outer layer 10, but they comprise the corrosion resistance enhancers mentioned above as additional elements.

The inner layer 7 preferably does not comprise any corrosion resistance enhancers or comprises only yttrium as corrosion resistance enhancer.

The total content of the corrosion resistance enhancers in the inner layer 7 is preferably lower than in the outer layer 10.

FIG. 2 shows by way of example a partial longitudinal section through a gas turbine 100.

In its interior, the gas turbine 100 has a rotor 103 which is mounted such that it can rotate about an axis of rotation 102, has a shaft 101, and is also referred to as the turbine rotor.

An intake casing 104, a compressor 105, a for example toric combustion chamber 110, in particular an annular combustion chamber, with a plurality of coaxially arranged burners 107, a turbine 108 and the exhaust gas casing 109 follow one another along the rotor 103.

The annular combustion chamber 110 is in communication with a for example annular hot gas duct 111. There, by way of example, four successive turbine stages 112 form the turbine 108.

Each turbine stage 112 is formed for example from two blade rings. As seen in the direction of flow of a working medium 113, a guide vane row 115 is followed in the hot gas duct 111 by a row 125 formed from rotor blades 120.

The guide vanes 130 are secured to an inner casing 138 of a stator 143, whereas the rotor blades 120 belonging to a row 125 are arranged on the rotor 103, for example by means of a turbine disk 133.

A generator (not shown) is coupled to the rotor 103.

While the gas turbine 100 is operating, air 135 is drawn in through the intake casing 104 and compressed by the compressor 105. The compressed air provided at the turbine end of the compressor 105 is passed to the burners 107, where it is mixed with a fuel. The mixture is then burnt in the combustion chamber 110, forming the working medium 113. From there, the working medium 113 flows along the hot gas duct 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they can be cooled by means of a coolant.

Substrates of the components may likewise have a directional structure, i.e. they are in single-crystal fatal (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110.

Superalloys of this type are known for example from EP 1 204 776 B1, EP 1 306 454, EP 1 319 729 A1, WO 99/67435 or WO 00/44949; these documents foun part of the disclosure with regard to the chemical composition of the alloys.

The guide vane 130 has a guide vane root (not shown here) facing the inner casing 138 of the turbine 108 and a guide vane head at the opposite end from the guide vane root. The guide vane head faces the rotor 103 and is fixed to a securing ring 140 of the stator 143.

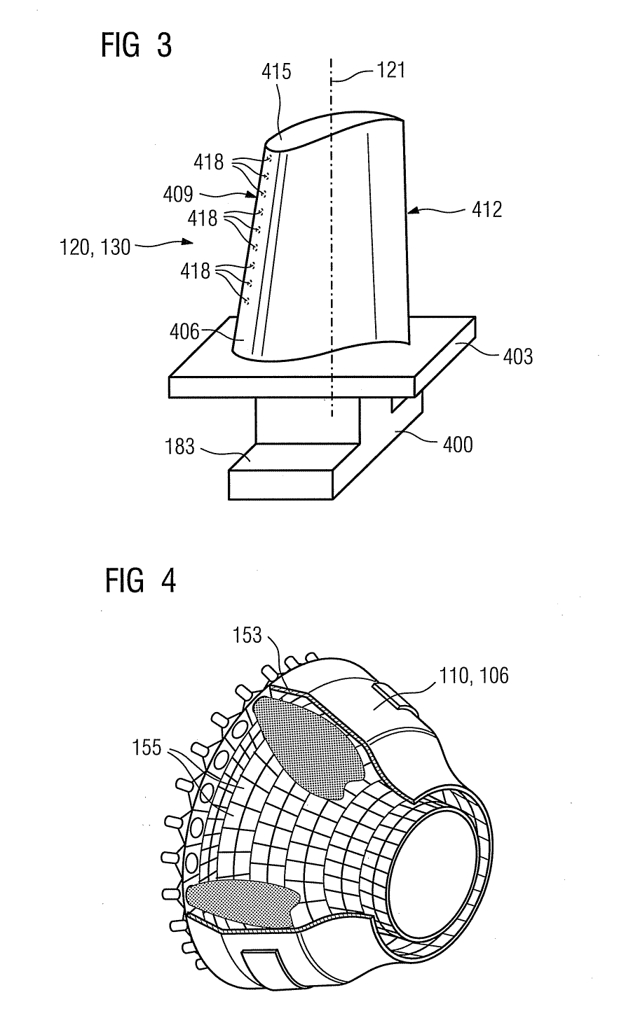

FIG. 3 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403, a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloy.

The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to fault the single-crystal structure, i.e. the single-crystal workpiece, or solidifies directionally.

In this case, dendritic crystals are oriented along the direction of heat flow and fowl either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably foiins transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1; these documents form part of the disclosure with regard to the solidification process.

The blades or vanes 120, 130 may likewise have coatings protecting against corrosion or oxidation, e.g. MCrAIX according to the invention (M is at least one element selected from the group consisting of iron (Fe), cobalt (Co), nickel (Ni), X is an active element and stands for yttrium (Y) and/or silicon and/or at least one of the rare earth elements, or hafnium (Hf)). Alloys of this type are known from EP 0 486 489 B1, EP 0 786 017 B1, EP 0 412 397 B1 or EP 1 306 454 A1, which are intended to form part of this disclosure with regard to the chemical composition of the alloy.

The density is preferably 95% of the theoretical density.

A protective aluminum oxide layer (TGO=thermally grown oxide layer) is formed on the MCrAIX layer (as an interlayer or as the outermost layer).

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAIX layer.

Columnar grains are produced in the thermal barrier coating by means of suitable coating processes, such as for example electron beam physical vapor deposition (EB-PVD).

Other coating processes are conceivable, for example atmospheric plasma spraying (APS), LPPS, VPS or CVD. The thermal barrier coating may have grains that are porous and/or include micro-cracks or macro-cracks in order to improve the resistance to thermal shocks. Therefore, the thermal barrier coating is preferably more porous than the MCrAlX layer.

The blade or vane 120, 130 may be hollow or solid in form. If the blade or vane 120, 130 is to be cooled, it is hollow and may also have film-cooling holes 418 (indicated by dashed lines).

FIG. 4 shows a combustion chamber 110 of the gas turbine 100. The combustion chamber 110 is configured, for example, as what is known as an annular combustion chamber, in which a multiplicity of burners 107, which generate flames 156 and are arranged circumferentially around an axis of rotation 102, open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

A cooling system may also be provided for the heat shield elements 155 and/or their holding elements, on account of the high temperatures in the interior of the combustion chamber 110. The heat shield elements 155 are then for example hollow and may also have cooling holes (not shown) which open out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX, in particular according to the invention: M is at least one element selected from the group consisting of iron (Fe), cobalt (Co), nickel (Ni), X is an active element and stands for yttrium (Y) and/or silicon and/or at least one of the rare earth elements, or hafnium (Hf). Alloys of this type are known from EP 0 486 489 B1, EP 0 786 017 B1, EP 0 412 397 B1 or EP 1 306 454 A1, which are intended to form part of this disclosure with regard to the chemical composition of the alloy.

A for example ceramic theimal barrier coating, consisting for example of ZrO₂, Y₂O₃—ZrO₂, i.e. unstabilized, partially stabilized or fully stabilized by yttrium oxide and/or calcium oxide and/or magnesium oxide, may also be present on the MCrAIX.

Columnar grains are produced in the thermal barrier coating by suitable coating processes, such as for example electron beam physical vapor deposition (EB-PVD).

Other coating processes are conceivable, for example atmospheric plasma spraying (APS), LPPS, VPS or CVD. The thermal barrier coating may have grains that are porous and/or include micro-cracks or macro-cracks in order to improve the resistance to thermal shocks.

Refurbishment means that after they have been used, protective layers may have to be removed from turbine blades or vanes 120, 130, heat shield elements 155 (e.g. by sand-blasting). Then, the corrosion and/or oxidation layers and products are removed. If appropriate, cracks in the turbine blade or vane 120, 130 or the heat shield element 155 are also repaired. This is followed by recoating of the turbine blades or vanes 120, 130, heat shield elements 155, after which the turbine blades or vanes 120, 130 or the heat shield elements 155 can be reused.

1.-30. (canceled)

31. A NiCoCrAl layer, comprising an element selected from the group consisting of
cerium;
tantalum;
niobium;
silicon;
titanium;
a rare earth element;
zirconium;
hafnium, and
a combination thereof,
wherein the layer is at least 1% by weight and at most 5% by weight, and
wherein the element is used as a corrosion resistance enhancer.

32. The NiCoCrAl layer as claimed in claim 31, wherein the rare earth element comprises yttrium.

33. The NiCoCrAl layer as claimed in claim 31, wherein the rare earth element consists of yttrium.

34. The NiCoCrAl layer as claimed in claim 31,
wherein the layer is at least 0.5% by weight of the plurality of elements, cerium, tantalum, niobium, silicon, titanium, zirconium and/or hafnium, and
wherein the layer further comprises the rare earth element.

35. The NiCoCrAl layer as claimed in claim 31, using at least the additions of silicon, zirconium, cerium, hafnium and/or yttrium, in particular only the additions of silicon, zirconium, cerium, hafnium and/or yttrium.

36. The NiCoCrAl layer as claimed in claim 31, wherein a content which includes silicon, zirconium, cerium and/or hafnium is >0.5% by weight.

37. The NiCoCrAl layer as claimed in claim 31, wherein the selected element only comprises silicon as the corrosion resistance enhancer.

38. The NiCoCrAl layer as claimed in claim 31, wherein the selected element only comprises zirconium as the corrosion resistance enhancer.

39. The NiCoCrAl layer as claimed in claim 31, wherein the selected element only comprises cerium as the corrosion resistance enhancer.

40. The NiCoCrAl layer as claimed in claim 31, wherein the selected element only comprises hafnium as the corrosion resistance enhancer.

41. The NiCoCrAl layer as claimed in claim 31, wherein the selected element only comprises yttrium and silicon as the corrosion resistance enhancer.

42. The NiCoCrAl layer as claimed in claim 31, wherein the selected element only comprises yttrium and cerium as the corrosion resistance enhancer.

43. The NiCoCrAl layer as claimed in claim 31, wherein the selected element only comprises yttrium and zirconium as the corrosion resistance enhancer.

44. The NiCoCrAl layer as claimed in claim 31, wherein the selected element only comprises yttrium, silicon and zirconium as the corrosion resistance enhancer.

45. The NiCoCrAl layer as claimed in claim 31, wherein a rare earth element content is at least 0.3% by weight.

46. The NiCoCrAl layer as claimed in claim 31, comprising in a weight percentage, Ni-(24-26) Co-(16-18) Cr-(9-11) Al-(0.3-0.) Y-(1.0-2.5) Re.

47. The NiCoCrAl layer as claimed in claim 31, comprising in a weight percentage, Ni-(11-13) Co-(20-22) Cr-(10-12) Al-(0.3-0.5) Y-(1.5-2.5) Re.

48. The NiCoCrAl layer as claimed in claim 31, comprising in a weight percentage, Co-(27-29) Ni-(23-25) Cr-(9-11) Al-(0.5-0.7)Y.

49. The NiCoCrAl layer as claimed in claim 31, comprising in a weight percentage, Co-(29-31) Ni-(27-29) Cr-(7-9) Al-(0.5-0.7) Y-(0.06-0.8)Si.

50. A metallic layer system, comprising:
an inner metallic layer; and
an outer metallic layer, comprising:
a NiCoCrAl layer, comprising an element selected from the group consisting of:
cerium,
tantalum,
niobium,
silicon,
titanium,
a rare earth element,
zirconium,
hafnium, and
a combination thereof,
wherein the layer is at least 1% by weight and at most 5% by weight, and
wherein the element is used as a corrosion resistance enhancer.
